(19) United States
(12) Patent Application Publication
(10) Pub. No.: US 2004/0161645 A1
(43) Pub. Date: Aug. 19, 2004

(54) Method for controlling a fuel cell system and systems for executing the method

(75) Inventors: Thomas Poschmann, Ulm (DE); Norbert Wiesheu, Guenzburg (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler AG, Stuttgart (DE)

(21) Appl. No.: 10/777,427

(22) Filed: Feb. 12, 2004

(30) Foreign Application Priority Data
Feb. 14, 2003 (DE) DE 103 06 237.8

(51) Int. Cl. H01M 8/04; H01M 8/06

(52) U.S. Cl. 429/17; 429/25; 429/19

(57) ABSTRACT

A method for controlling a fuel cell system that has a high-pressure gas generating system so as to avoid mechanical damage to a fuel cell. In the event of a malfunction of a diaphragm of a reformer unit, the differential pressure between the side of the diaphragm of the reformer unit facing the anode side and the cathode side of the fuel cell module is held below a predefined value. In addition fuel cell systems are provided for holding the differential pressure may contain a pressure relief valve, which may be controlled by a sensor, a bursting disk, or a flow resistance, or another controllable valve on the low-pressure side upstream from the anode side of fuel cell unit.

Priority is claimed to German Patent Application No. DE 103 06 237.8, filed Feb. 14, 2003, the entire disclosure of which is incorporated by reference herein.

### BACKGROUND

The present invention relates to a method for controlling a fuel cell system in which hydrogen-containing reformer gas is produced in a reformer unit by selectively separating the reformer gas from a gas mixture using a diaphragm module and systems for executing the method.

Fuel cells are composed of an anode side and a cathode side, each having a channel system for fluids. A diaphragm electrode unit (DEU) separates the anode side from the cathode side. For generating electric power, the channel systems may be supplied with specific gases. In a preferred embodiment of a fuel cell, hydrogen flows through the anode space and a compressor makes oxygen or air flow through the cathode space. If hydrogen is produced from a hydrocarbon in a reformer unit situated upstream from the anode side of the fuel cell, this may take place using a low-pressure system or a high-pressure system. In low-pressure systems, the anode side of a fuel cell is directly flushed by the reformer gas flow.

Hydrogen separation technologies, in particular diaphragm modules, are used in high-pressure systems in which pure hydrogen is separated from a gas mixture via separation diaphragms. The greater the pressure differential between the two sides of the particular diaphragm and the thinner the foil-type diaphragm, the more efficiently operate the separation diaphragms. The danger in the case of high-pressure differentials and thin foils is that the diaphragm ruptures, so that pressure compensation takes place between the high-pressure area of the reformer unit and the anode space of the fuel cell. However since the cathode side still remains on the compressor pressure level, a pressure differential is established across the diaphragm electrode unit. The diaphragm electrode unit may be damaged if this pressure differential exceeds a design-specific value, which may result in complete failure of a fuel cell.

A fuel cell system having a pressure adjustment and a control method are described in Unexamined Patent Application DE 101 07 019 A1. In this system, a reformer unit for producing hydrogen-containing reformer gas is connected to at least one fuel cell. Devices for adjusting the operating pressure are assigned to the reformer unit and to the fuel cell. At least one of the devices, in particular a throttle device or an expander, for adjusting the operating pressure is connected between the reformer unit and the anode side of the fuel cell. The system and the control method cause targeted decoupling of the operating pressures of the reformer unit and the fuel cell. The devices for adjusting the operating pressure ensure the required pressure conditions in normal operation of the fuel cell.

Feed lines and discharge lines for a fuel and an oxidation agent are provided in the anode part and the cathode part of the fuel cell according to DE 100 10 394 A1. Pressure regulators, which are coupled to one another, are situated in the discharge lines so that an exchange of the pressure values takes place between the pressure regulators during normal operation of the fuel cell.

In the fuel cell system according to DE 100 41 125 A1, an anode circuit and a cathode circuit are connected via a connecting line, a controllable valve system being situated in the connecting line for pressure compensation during warm-up operation and during normal operation.

A method for detecting perforations in a diaphragm of an electrochemical cell is described in DE 697 04 571 T2 in which the exothermally generated heat is detected when a reactant fluid of a high-pressure side impinges on a reactant fluid on the low-pressure side and both reactant fluids react generating heat. Using catalysts may accelerate the exothermal reaction. The signal generated by the heat detector may be used to signal the damage to the cell.

JP 60-007 065 A1 describes a fuel cell system in which differential pressure sensors are provided on both the anode side and the cathode side. If differential pressure limiting values are exceeded on the anode side or the cathode side, a computer-controlled outlet valve is opened on the anode side or the cathode side.

With regard to rapidity and reliability, the known fuel cell systems are not designed to control the pressure conditions in the event of malfunction. This is true in particular in high-pressure systems.

### SUMMARY OF THE INVENTION

An object of the present invention is to provide a method for controlling a fuel cell system and systems for executing the method which, when a high-pressure gas-generating system is used, reliably prevent mechanical damage to a fuel cell in the event of gas break-through to the low-pressure side.

The present invention provides a method for controlling a fuel cell system in which hydrogen-containing reformer gas is produced in a reformer unit by selectively separating the reformer gas from a gas mixture using a diaphragm module. In normal operation of the fuel cell system having a diaphragm, the gas mixture is kept under a higher pressure than the separated reformer gas, the reformer gas being supplied to the anode side of a fuel cell module made up of at least one fuel cell. An oxidation agent is supplied to the cathode side of the fuel cell module, the fluids on the anode side and the cathode side are separated in normal operation by a separation diaphragm and held under predefined pressures. In the event of malfunction, e.g., bursting of the diaphragm, of the reformer unit, the differential pressure between the side of the reformer unit diaphragm facing the anode side and the cathode side of the fuel cell module is held below a predefined value.

The present invention also provides a system for executing the method includes a reformer unit for producing a hydrogen-containing reformer gas using a diaphragm module which contains a diaphragm which separates a high-pressure area from a low-pressure area, including a fuel cell module having at least one fuel cell which is composed of an anode side and a cathode side which are separated from one another by a separation diaphragm, the anode side being connected to the low-pressure area of the diaphragm module, and the cathode side being connected to a device for supplying an oxidation agent, wherein the volume for the circulation of fluids on the high-pressure side (15) is substantially smaller than the volume for the circulation of fluids on the low-pressure side (16).

In addition, the present invention provides a system for executing the method comprising a reformer unit for producing a hydrogen-containing reformer gas using a diaphragm module which contains a diaphragm which separates a high-pressure area from a low-pressure area, including a fuel cell module having at least one fuel cell which is composed of an anode side and a cathode side which are separated from one another by a separation diaphragm, the anode side being connected to the low-pressure area of the diaphragm module, and the cathode side being connected to a device for supplying an oxidation agent, wherein a pressure relief valve (29) is situated in the connection (21) between the low-pressure area (16) of the diaphragm module (4) and the anode side (18) of the at least one fuel cell (2).

The present invention furthermore provides a system for executing the method, comprising a reformer unit for producing a hydrogen-containing reformer gas using a diaphragm module which contains a diaphragm which separates a high-pressure area from a low-pressure area, including a fuel cell module having at least one fuel cell which is composed of an anode side and a cathode side which are separated from one another by a separation diaphragm, the anode side being connected to the low-pressure area of the diaphragm module, and the cathode side being connected to a device for supplying an oxidation agent, wherein a bursting disk (36) is situated in the connection (21) between the low-pressure area of the diaphragm module (4) and the anode side (18) of the at least one fuel cell (2).

In the method according to the present invention, the pressure conditions in a reformer unit, as well as in the connected fuel cells, are taken into account. Due to the fact that in the event of malfunction, i.e., bursting of the reformer unit diaphragm, the differential pressure between the side of the reformer unit diaphragm facing the anode side and the cathode side of the fuel cell module is held below a predefined value, mechanical damage to the diaphragm electrode units may be prevented.

In an advantageous system for executing the method, the volume for the circulation of fluids on the high-pressure side of a reformer unit is substantially smaller than the volume for the circulation of fluids on the low-pressure side of the reformer unit and the fuel cell. In the event of a breakthrough of the reformer unit diaphragm, the pressure, volume, and temperature are equalized in the overall system composed of the high-pressure side and the low-pressure side including the anode space of the fuel cells. The mixture pressure established is always lower than the critical overpressure toward the cathode side of the particular fuel cell, so that the diaphragm electrode units between the anode sides and the cathode sides of the fuel cells are not damaged. A small volume on the high-pressure side is advantageous for the system dynamics. A large volume on the low-pressure side may advantageously be used as a hydrogen buffer for load change conditions.

In a further advantageous system for executing the method, a pressure relief valve is situated in the connection between the low-pressure area of the diaphragm module of a reformer unit and the anode side of at least one fuel cell. In the event of rupture of the reformer unit diaphragm, the pressure relief valve is quickly opened and the pressure is released into the atmosphere. Damage to the diaphragm electrode units of the fuel cells is thus prevented. The pressure relief valve may be controlled by an actuator whose actuating signals are formed in a control device using sensors which detect the pressure on the low-pressure side of the reformer unit diaphragm or the carbon monoxide or carbon dioxide concentration. A bursting disk may also be provided instead of the pressure relief valve. If it is anticipated that, in the event of a malfunction, pressure equalization does not take place quickly enough, pressure equalization in the anode space of a fuel cell may be delayed via a flow resistance, the flow resistance being situated upstream from the anode space.

In a variant of the system for executing the method, a shut-off valve, able to be shut in the event of rupture of the diaphragm in the diaphragm module, may additionally be situated in the connection between the low-pressure side of the diaphragm module of a reformer unit and the anode space of a fuel cell.

### BRIEF DESCRIPTION OF THE DRAWINGS

The present invention is explained in greater detail below on the basis of exemplary embodiments with reference to the drawings, in which:

FIG. 1 shows a schematic representation of a fuel cell system including a reformer unit,

FIG. 2 shows a schematic representation of a protection system for a diaphragm electrode unit using a bursting disk,

FIG. 3 shows a schematic representation of an active anode protection system using a controllable valve, and

FIG. 4 shows a schematic representation of an active anode protection system using a controllable valve in combination with a flow resistance.

### DETAILED DESCRIPTION

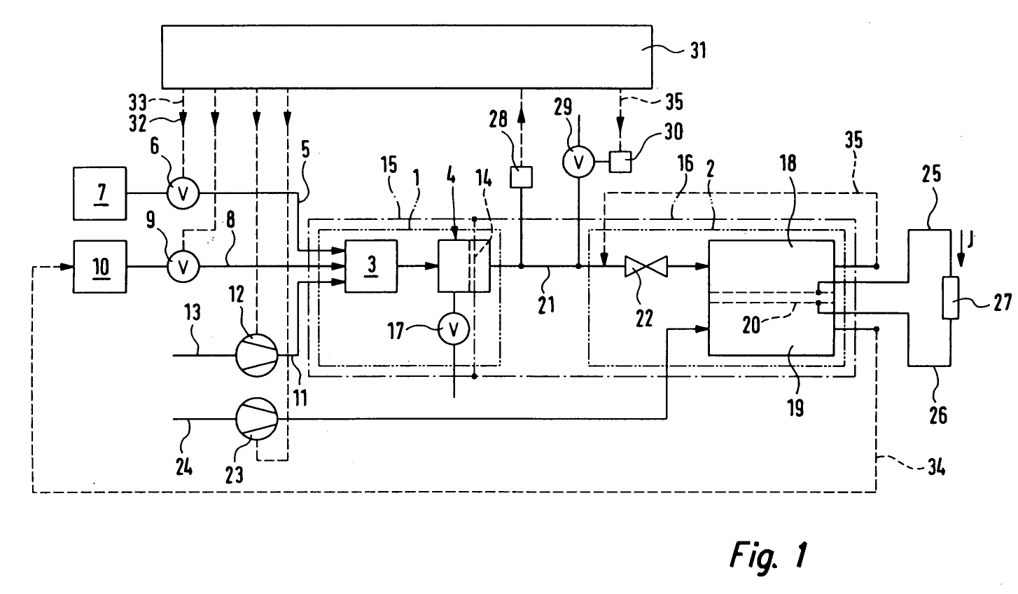

FIG. 1 shows a schematic representation of a fuel cell system for carrying out the method. The core of the fuel cell system is composed of a reformer unit 1 and a fuel cell unit 2 which are each indicated by dash-two-dots lines

Reformer unit 1 contains a reformer 3 and a diaphragm module 4. Reformer 3 is connected to a fuel tank 7 such as a gasoline tank, a diesel tank, or a methanol tank, for example, via a line 5 and a controllable valve 6. Furthermore, reformer 3 is connected to a water tank 10 via a line 8 and a controllable valve 9. Finally, reformer 3 is connected to a compressor 12 having a suction line 13 via a line 11. The outlet of reformer 3 is connected to diaphragm module 4. Diaphragm module 4 contains a diaphragm 14 which separates the fuel cell system into a high-pressure area 15 and a low-pressure area 16, adjoining one another, schematically depicted in FIG. 1 by dash-dot lines. A pressure-retaining valve 17 is connected to the high-pressure side of diaphragm module 4.

Fuel cell unit 2 contains a fuel cell battery made up of fuel cell modules. FIG. 1 shows only one fuel cell module composed of an anode side 18 and a cathode side 19 which are separated from one another by a diaphragm electrode unit 20. Anode side 18 is connected to the low-pressure side of diaphragm module 4 via a line 21. A flow resistance 22 is integrated into line 21. On the inlet side, cathode side 19 is connected to a compressor 23 having a suction line 24. On the outlet side, anode side 18 and cathode side 19 are connected respectively to line 21 and water tank 10. Two current leads 25, 26 run from diaphragm electrode unit 20 to a consumer 27.

A sensor 28 and, in parallel to it, a controllable pressure relief valve 29 are integrated into line 21 upstream from flow resistance 22. Valves 6, 9, an actuator 30 for pressure relief valve 29, compressors 12, 23, and sensor 28 are connected to a control device 31. Arrows 32 in lines 33, depicted by dashed lines, which run to control device 31, indicate the signal flow directions.

During normal operation of the fuel cell system, valves 6, 9 are open, compressors 12, 23 are in action, and pressure relief valve 29 is closed. From the hydrocarbon-containing fuel of fuel tank 7 such as gasoline, diesel, or methanol, for example, the water of water tank 10, and the oxygen of the air pumped into reformer 3 by compressor 12, a hydrogen-rich gas mixture is produced in reformer 3 by reforming. Reformer 3 is a high-pressure system, i.e., the pressure of the gas mixture in reformer 3 and on the high-pressure side of diaphragm module 4 is substantially higher than the pressure of the oxygen-containing air on cathode side 19 of fuel cell unit 2 which is built up by compressor 23. Pressure-retaining valve 17 on the high-pressure side of diaphragm module 4 ensures constant high pressure. Corresponding to the general gas law, a situation is established in high-pressure area 15 in which the pressure is proportional to a quotient formed by the volume of high-pressure area 15 and the temperature. Hydrogen, which accumulates on the low-pressure side of diaphragm 14, is separated from the hydrogen-rich gas mixture by diaphragm module 4. An electrochemical reaction takes place in fuel cell unit 2 between hydrogen on the anode side 18 and atmospheric oxygen on the cathode side 19, thereby creating an electromotive force which causes current I flow through consumer 27. During the electrochemical reaction, water is produced on cathode side 19 which may be routed back to water tank 10 via line 34, depicted with a dashed line. Likewise, unused hydrogen on the anode side may be routed back to the inlet of anode side 18 via line 35, depicted with a dashed line. The pressures in line 21 are roughly equal on both sides of flow resistance 22, so that almost no pressure drop exists upstream of flow resistance 22. The pressure in line 21, i.e., low-pressure area 16, is constantly monitored using sensor 28. The carbon monoxide or carbon dioxide content may be monitored using sensor 28 as an alternative.

If diaphragm 14 in diaphragm module 4 bursts, a new pressure balance occurs in high-pressure area 15 and low-pressure area 16. In this event of malfunction, the high-pressure from high-pressure area 15 is released into low-pressure area 16. Without the measures according to the present invention, a differential pressure would exist between anode side 18 and cathode side 19 of fuel cell unit 2, which would result in damage to diaphragm electrode unit 20.

Different measures according to the present invention are implemented which, individually or in combination, prevent the destruction of diaphragm electrode unit 20.

As a first measure, the volumes in high-pressure area 15 and low-pressure area 16 may be dimensioned such that, in the event of diaphragm 14 bursting, a mixture pressure is established which is lower than the critical overpressure toward cathode side 19. This may be achieved by dimensioning the volume in high-pressure area 15 as small as possible compared to the volume of low-pressure area 16. If the volume in low-pressure area 16 is dimensioned to be six to eight times larger than in high-pressure area 15, then, in the event of diaphragm 14 bursting, a pressure increase by a factor of only 1.4 to 1.1 results in the total volume formed from the volumes of reformer 3, diaphragm module 4, anode side 18 of fuel cell unit 2, and the associated pressure-connected elements such as line 21, sensor 28, pressure relief valve 29, and flow resistance 22. This moderate pressure increase poses no danger for diaphragm electrode unit 20. The pressure differential between anode side 18 and cathode side 19 of fuel cell unit 2 does not exceed a critical threshold of typically 500 mbar.

As a further measure, the signal of sensor 28 may be used for detecting the ruptured state of diaphragm 14. Bursting of diaphragm 14 results in rapid pressure increase in low-pressure area 16 which may be detected by sensor 28 which responds to rapid pressure changes. When diaphragm 14 bursts, the reformer gas continues to flow unobstructed into anode side 18 of fuel cell element 2. However, the reformer gas contains a high concentration of carbon monoxide and carbon dioxide which is detectable by a sensor 28 for detecting carbon monoxide or carbon dioxide. The signal of sensor 28 is analyzed in control device 31 and an actuating signal is generated for actuator 30. Signal processing in control device 31 takes place at such high speed that the overpressure in low-pressure area 16 is reliably reduced. The actuating signal at actuator 30 causes a rapid opening of pressure relief valve 29. The pressure increase cannot continue to anode side 18, whereby diaphragm electrode unit 20 is protected.

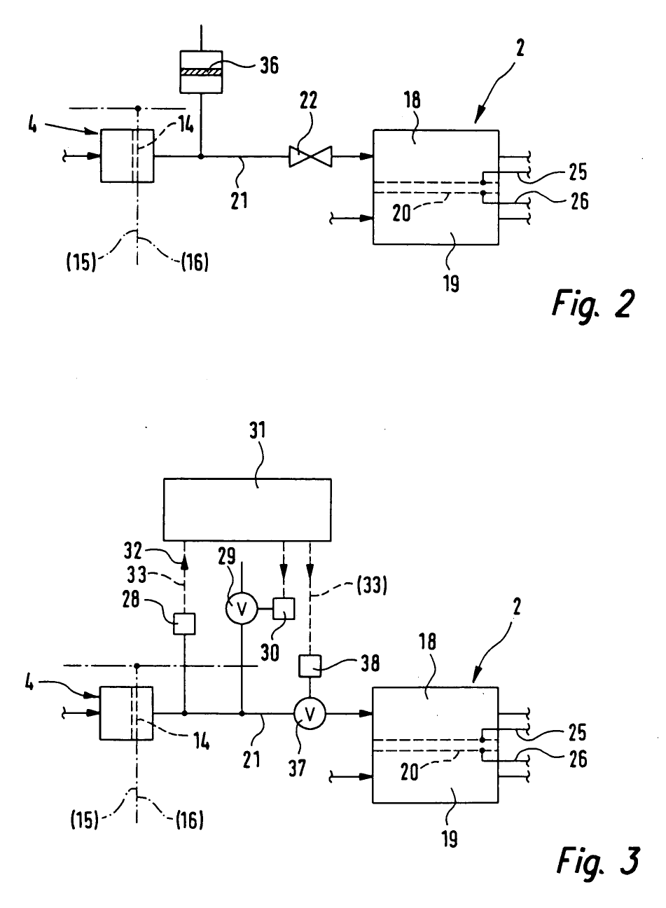

A variant having a bursting disk 36 in line 21 is shown in FIG. 2. Otherwise, the fuel cell system has the design described in FIG. 1. Bursting disk 36 functionally substitutes sensor 28 and pressure relief valve 29 of FIG. 1. At an unacceptably high pressure, such as occurs in low-pressure area 16 when diaphragm 14 is ruptured, bursting disk 36 is ruptured so that the overpressure dissipates into the atmosphere. As described in connection with FIG. 1, the pressure increase cannot continue to anode side 18, whereby diaphragm electrode unit 20 is also protected.

In the method as recited in claim 1, as well as in the method as recited in claim 2, flow resistance 22 is used to prevent damage to diaphragm electrode unit 20 while pressure decreases. In the event of rupture of diaphragm 14, flow resistance 22 causes a delay of pressure equalization on anode side 18 of fuel cell unit 2. Fuel cell unit 2 is operated at low pressure, i.e., the volume flow in stationary normal operation is proportional to the hydrogen consumption on anode side 18. Because the volume flow in high-pressure area 15 contains all remaining gases in addition to unseparated hydrogen, the volume flow is substantially larger than in low-pressure area 16. According to the general gas law, the volume flow in the high-pressure area is accordingly small under high operating pressure. When diaphragm 14 bursts, the volume flow in the event of malfunction is released into anode side 18 of fuel cell unit 2 and thereby increases. Flow resistance 22 is designed in such way that it allows for a minimal pressure drop during normal operation and a very high pressure drop in the event of damage in order to be able to dissipate the gas flow in space and time via pressure relief valve 29 or bursting disk 36 and to simultaneously ensure minimal pressure increase in anode side 18.

Based upon FIG. 3, a further measure involving active anode protection is explained. The fuel cell system shown in FIG. 3 essentially represents the system shown in FIG. 1, with the exception that, instead of flow resistance 22, a controllable valve 37 having an actuator 38 is provided in line 21. As described above, rupture of diaphragm 14 is detected by sensor 28. The signal of sensor 28 is processed in control device 31. Actuating signals for actuators 30, 38 are generated in control device 31. The actuating signal at actuator 38 initially causes valve 37 to be shut off thereby interrupting the connection between anode side 18 and diaphragm module 4 and protecting diaphragm electrode unit 20. Pressure relief valve 29 is simultaneously or subsequently opened via the actuating signal at actuator 30 so that the gas mixture is blown off into the atmosphere. Of course, pressure relief valve 29 and valve 37 may be combined into a three-way valve so that the hydrogen path is diverted directly into the atmosphere.

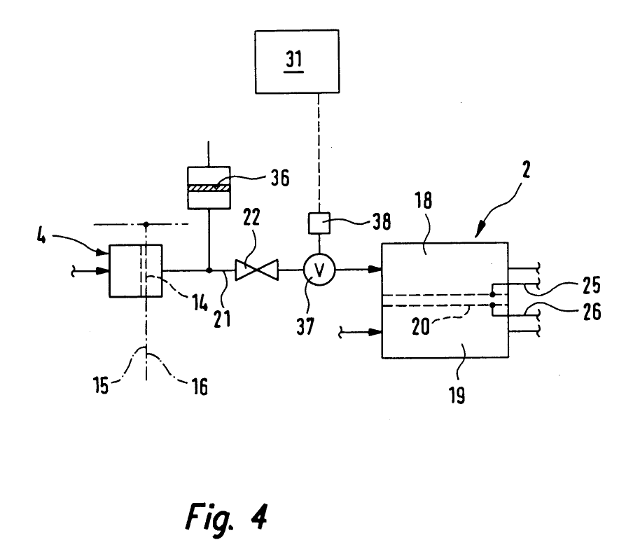

FIG. 4 shows a variant which is a combination of a bursting disk 36 according to FIG. 2 or a pressure relief valve 29 according to FIG. 3 with a flow resistance 22 and a controllable valve 37 connected in series in line 21. In the event rupture of diaphragm 14, flow resistance 22 prevents rapid pressure increase on the anode side of fuel cell unit 2 as a function of the pressure differential between high-pressure area 15 and low-pressure area 16. If the pressure on the anode side 18 becomes too high, valve 37 is shut off by control device 31, thereby preventing an overpressure in fuel cell unit 2. If the pressure in line 21 upstream from flow resistance 22 rises too rapidly to an inadmissibly high value, bursting disk 36 bursts or a pressure relief valve 29 vents in place of bursting disk 36. According to this variant, a double, redundant protection of fuel cell unit 2 is provided against overpressure in low-pressure area 16 due to the rupture of diaphragm 14.

All measures for protecting diaphragm electrode unit 20 have in common the fact that in the event of rupture of diaphragm 14 the supply of non-reformed fuel such as methane, methanol, diesel, or gasoline, as well as the supply of water and air are interrupted by control device 31 which, if needed, shuts off valves 6, 9 and/or shuts down compressors 12, 23. This reliably prevents diaphragm electrode unit 20 from bursting or being contaminated.

What is claimed is:

1. A method for controlling a fuel cell system, in which a hydrogen-containing reformer gas is produced in a reformer unit by selectively separating the reformer gas from a gas mixture using a diaphragm module having a diaphragm, the method comprising:
during normal operation of the fuel cell system:
keeping the gas mixture at a higher pressure than the separated reformer gas;
supplying the reformer gas to an anode side of a fuel cell module; and
supplying an oxidation agent to a cathode side of the fuel cell module, the fluids on the anode side and the cathode side of the fuel cell module being separated by a separation diaphragm unit; and
during abnormal operation including a bursting of the diaphragm:
holding a pressure differential between a side of the reformer unit facing the anode side and the cathode side of the fuel cell module below a predefined value.

2. The method as recited in claim 1, wherein the differential pressure is essentially held below 500 mbar.

3. A fuel cell system, comprising:
a reformer unit for producing a hydrogen-containing reformer gas using a diaphragm module having a diaphragm, the diaphragm separating a high-pressure area of the fuel system from a low-pressure area of the fuel cell system, the high-pressure area including a first fluid circulation volume and the low-pressure area including a second fluid circulation volume, the first volume being substantially smaller than the second volume; and
a fuel cell module having at least one fuel cell, the fuel cell having an anode side and a cathode side separated from each other by a separation diaphragm unit, the anode side being connected to a side of the diaphragm module in the low-pressure area, and the cathode side being connected to a device for supplying an oxidation agent.

4. The fuel cell system wherein a third volume for the circulation of fluids in the fuel cell module is at least six times that of the first volume.

5. A fuel cell system, comprising:
a reformer unit for producing a hydrogen-containing reformer gas using a diaphragm module having a diaphragm separating a high-pressure area of the diaphragm module from a low-pressure area of the diaphragm module;
a fuel cell module including at least one fuel cell having an anode side and a cathode side separated from one another by a separation diaphragm unit, the anode side being connected to the low-pressure area of the diaphragm module, and the cathode side being connected to a device for supplying an oxidation agent; and
a pressure relief valve disposed between the low-pressure area of the diaphragm module and the anode side of the at least one fuel cell.

6. The fuel cell system as recited in claim 5, further comprising a pressure sensor controlling the pressure relief valve.

7. The fuel cell system as recited in claim 5, further comprising a sensor controlling the pressure relief valve, a signal of the sensor representing at least one of a carbon monoxide content and a carbon dioxide content on a low-pressure side of the diaphragm.

8. The fuel cell system as recited in claim 5, further comprising a flow resistance connection disposed between the low-pressure area of the diaphragm module and the anode side of the at least one fuel cell.

9. The fuel cell system as recited in claim 5, further comprising a shut-off valve disposed between the low-pressure area of the diaphragm module and the anode side of the at least one fuel cell, the shut-off valve configured to shut off in the event of rupture of the diaphragm.

10. A fuel cell system comprising:
a reformer unit for producing a hydrogen-containing reformer gas using a diaphragm module having a diaphragm separating a high-pressure area from a low-pressure area;
a fuel cell module including at least one fuel cell having an anode side and a cathode side separated from one another by a separation diaphragm unit, the anode side being connected to the low-pressure area of the diaphragm module, and the cathode side being connected to a device for supplying an oxidation agent; and
a bursting disk disposed a connection between the low-pressure area of the diaphragm module and the anode side of the at least one fuel cell.
